(19) United States
(12) Patent Application Publication
(10) Pub. No.: US 2007/0253795 A1
(43) Pub. Date: Nov. 1, 2007

(54) Fixing Cover

(75) Inventor: David H. Woolstencroft, Lancashire (GB)

Correspondence Address: VENABLE LLP, P.O. BOX 34385, WASHINGTON, DC, 20043-9998, US

(73) Assignee: Appleyard Lees, Leeds (GB)

(21) Appl. No.: 11/596,316

(22) PCT Filed: May 4, 2005
(86) PCT No.: PCT/GB05/01678

§ 371 Date: Jun. 28, 2007

(30) Foreign Application Priority Data
May 10, 2004 (GB) 0410307.3

(51) Int. Cl. F16B 37/14

(52) U.S. Cl. 411/429

(57) ABSTRACT

A fixing cover (10) is hexagonal in shape so as to cover a bolt head or nut (as shown schematically in FIG. 4). The cover (10) has a body which can be made of metal, which would normally be steel or spring steel. In the three spaced side walls (12a, b, c) there are inwardly projecting indentations (14a, 14b, 14c).

This invention relates to a fixing cover and to a method of protecting a fixing, in particular, but not limited to a fixing cover for a bolt or nut.

When constructing a building from a steel framework structure different elements of the structure are secured together with nuts and bolts. These are typically applied with grease in order to allow the nut and bolt fastenings to be tightened properly. It is also part of the usual procedure to paint the steel structure to deter corrosion. However, a problem arises in that the paint used cannot be applied to the grease that has been used to fasten the fixing. Consequently, it is necessary to perform a degreasing operation of the nut and bolt fixings before paintings can be performed. Alternatively the cover must be etched and primed so that it can be painted.

It is an object of the present invention to address the above mentioned disadvantage.

According to a first aspect of the invention a cover for a bolted construction joint fixing comprises a cover section and an attachment section, wherein an outer surface of the cover is adapted to receive a coating.

Advantageously, the cover removes the need to degrease or etch and prime a nut/bolt of a construction joint of a steel construction framework.

The cover is preferably adapted to receive a material such as paint, a concrete spray or another coating usually requiring surface preparation.

The cover may be made of steel, which may be spring steel or mild steel. The cover may be made of a heat resistant material, which may be polyester with a fire retardant element such as a dough moulding compound (dmc) and/or may include certam. The heat resistant material may be polymeric or may be ceramic, the heat resistant material may be moulded.

The cover section may be adapted to fit over a bolt head. The cover section may be adapted to fit over a nut and/or a nut and protruding bolt shank.

The attachment section may be threaded, preferably to allow attachment to a bolt shank. The attachment section may be an insert in the cover section.

The attachment section may comprise a plurality of protrusions adapted to engage a fixing. The protrusions may break a surface of the attachment section, preferably to form a clip. The protrusions may form bulges in a surface of the attachment section.

The cover may contain a filler material, which may be paint, such as intumescent paint, or may be a grease, or other moisture resistant substance. Alternatively, the filler material may be an adhesive material, which may form an attachment means of the cover.

The invention extends to a method of protecting a bolted construction joint fixing comprising securing a cover to a fixing for a bolted construction joint, said cover having an outer surface adapted to receive and retain a coating medium.

Preferably, the coating medium is a paint or may be a concrete spray.

The cover may be pushed onto a bolt head or onto a nut forming part of the bolted construction joint.

The cover may be screwed onto the bolted construction joint.

The invention extends to a method of manufacturing a bolted construction joint fixing comprising stamping a piece of metal in to a shape having a hexagonal opening and forming attachment sections in side walls of the hexagonal opening.

The attachment sections are preferably projections onto the hexagonal opening.

There are preferably three projections.

The projections may be blisters in the surface of the side walls. The projections may be slotted tabs in the side walls.

All of the features disclosed herein may be combined with any of the above aspects, in any combination.

For a better understanding of the invention, and to show how embodiments of the same may be carried into effect, reference will now be made, by way of example, to the accompanying diagrammatic drawings in which:

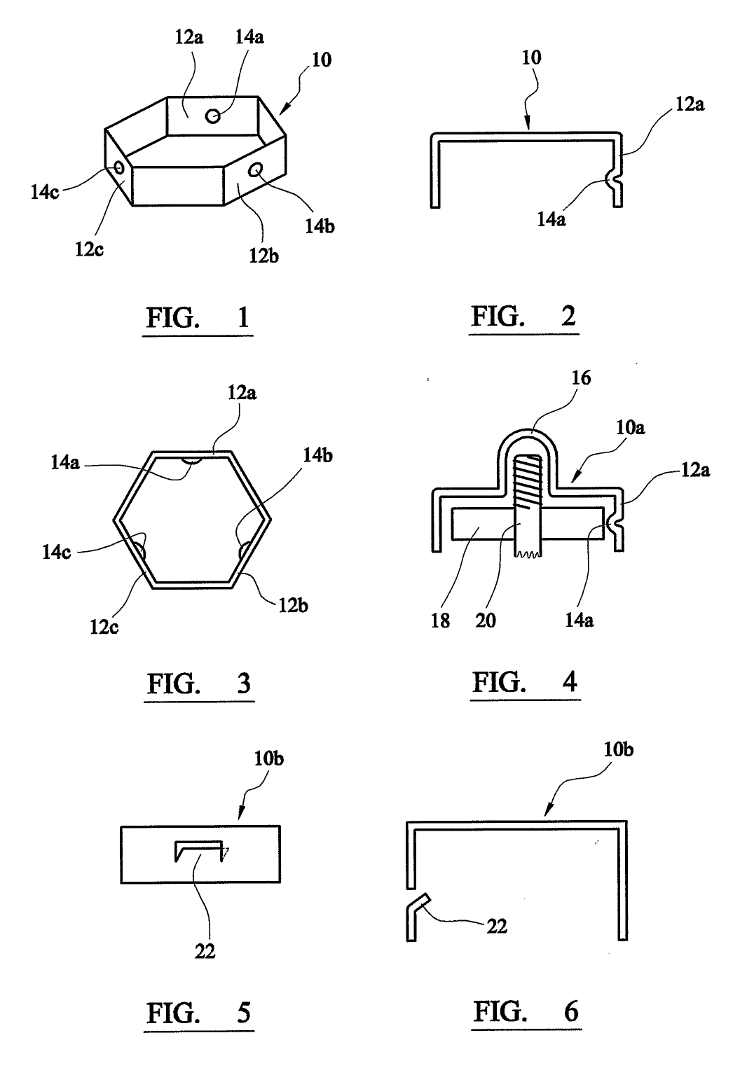

FIG. 1 is a schematic perspective view of a first embodiment of bolt cover;

FIG. 2 is a schematic cross-sectional side view of the first embodiment of bolt cover;

FIG. 3 is a schematic view from below of the first embodiment of bolt cover;

FIG. 4 is a schematic cross-sectional side view of a second embodiment of bolt cover;

FIG. 5 is a schematic side view of a third embodiment of bolt cover; and

FIG. 6 is a schematic cross-sectional view of the third embodiment of bolt cover.

In order to overcome the problem of having to degrease and prime a nut or bolt that forms part of a construction joint prior to painting or spraying with concrete, a cover 10 for a bolted joint is provided.

The cover 10 is hexagonal in shape so as to cover a bolt head or nut (as shown schematically in FIG. 4). The cover 10 has a body which is made of metal, which would normally be steel or spring steel. In the three spaced side walls 12a, b, c there are inwardly projecting indentations 14a, 14b, 14c.

The inward projections 14a, b, c are in the form of indentations or blisters which are of sufficient depth and extend sufficiently far into the cover 10 to provide an interference fit with a bolt head or nut (see FIG. 4) to which the cover 10 is applied.

Many different sizes of cover 10 are envisaged in order to fit any of the large of nut and bolt sizes that are available. The size of the inward projections 14a, b, c is chosen to provide an interference fit with the chosen bolt head or nut.

FIG. 2 shows a side view of one of the inward projections 14a. The inward projections 14a, b, c are formed by punching or stamping. The shape of the cover 10 is also produced by stamping prior to formation of the inward projections 14a, b, c.

The cover 10 provides a smooth outer surface for subsequent application of paint, concrete spray or another coating medium. The smooth outer surface is provided to maximise the interface for bonding with the paint etc without the need to prime and etch the surfaces of the bolt head, the nut or the bolt thread surfaces. Consequently, much time is saved by simply placing one of the covers over an exposed bolt head or nut for the subsequent application of paint.

Although referred to above as being made of metal, the cover 10 could be moulded from heat resistant material, which may be polyester DMC.

The cover 10 is particularly advantageous when the material for subsequent application is a concrete spray which is typically alkaline. The cover prevents the alkaline material from attacking the bolt or nut and causing corrosion.

The inside of the cover 10 may have additional material inserted therein prior to the cover 10 being applied to a bolt head or nut of a construction joint. Material could either be additional intumescent paint to provide extra protection should a prolonged heat exposure in a fire oxidise away the metal cover, or a grease (or other moisture resistant substance) to protect the bolted joint against corrosion. Alternatively, the additional material may be an adhesive compound to provide an alternative fixture method to the inward projections 14a to 14c referred to above.

FIG. 4 shows a second embodiment of cover 10a, which has much in common with the cover 10 discussed above. Like reference numerals have been used for the second embodiment of cover 10a for the same parts. The cover 10a has an additional projection 16 which allows the cover 10a to be placed over a nut 18 through which projects a threaded shank 20 of a bolt. The additional projection 16 may be produced by stamping. Alternatively, the additional projection 16 could be part of a moulding where the cover 10a is made from a heat resistant material, such as polyester.

FIGS. 5 and 6 show a third embodiment of cover 10b. In this embodiment, which may have the same shape as the first embodiment or the second embodiment the inward projections of the first embodiment 14a to c are replaced with tabs 22, only one is shown for clarity, but they have the same locations as shown in FIGS. 1 and 3 in relation to the additional projections 16. The tabs 22 extend inwardly into the cover 10b in the same way as the additional projection 16a, b, c. However, the tabs 22 break the surface of the material of the cover 10b, having been stamped through during production of the cover 10b. The tabs 22 effectively form gripping elements whereby the cover 10b grips a bolt or bolt head, in the same way as described above in relation to the first embodiment. The additional projection 16 discussed in relation to FIG. 4 can also be provided on the embodiment discussed in relation to FIGS. 5 and 6 when it is desired to place the cover 10b over a nut 18 and a projecting shank 20 of a bolt.

An alternative method of fixing the covers discussed above to a bolt shank 20 is to provide a thread on the inside of the additional projection 16 of the embodiment shown in FIG. 4. The thread (not shown) could engage the thread of the shank 20, instead of, or in addition to the inward projections 14a to 14c or tabs 22.

The covers described above all of significant advantages as described above in relation to the first embodiment in that degreasing and etching of nuts and bolt combinations is not required when subsequent painting or spray covering with concrete is to be carried out. Instead, a cover can simply be placed over a bolt head or a nut/bolt combination to provide a cover and a good clean surface which will receive the paint or spray concrete.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A cover for a bolted construction joint fixing comprises a cover section and an attachment section, wherein an outer surface of the cover is adapted to receive a coating.

2. A cover as claimed in claim 1, which is adapted to receive a coating such as paint, a concrete spray or another coating usually requiring surface preparation before application.

3. A cover as claimed in claim 1, which is made of steel.

4. A cover as claimed claim 1, which is made of a heat resistant material.

5. A cover as claimed in claim 4, in which the heat resistant material is polymeric or ceramic.

6. A cover as claimed in claim 4, which is made of polyester with a fire retardant element.

7. A cover as claimed in claim 1, which is adapted to fit over a bolt head and/or a nut and/or a nut and protruding bolt shank.

8. A cover as claimed in claim 7, in which the attachment section is threaded to allow attachment to a bolt shank.

9. A cover as claimed in claim 1, in which the attachment section is an insert in the cover section.

10. A cover as claimed in claim 1, in which the attachment section comprises a plurality of protrusions adapted to engage a fixing.

11. A cover as claimed in claim 10, in which the protrusions break a surface of the attachment section, to form a clip.

12. A cover as claimed in claim 10, in which the protrusions form bulges in a surface of the attachment section.

13. A cover as claimed in claim 1, which contains a filler material.

14. A cover as claimed in claim 13, in which the filler is be paint, or a grease, or other moisture resistant substance.

15. A cover as claimed in claim 13, in which the filler material is an adhesive material that forms an attachment means of the cover.

16. A method of protecting a bolted construction joint fixing comprises securing a cover to a fixing for a bolted construction joint, said cover having an outer surface adapted to receive and retain a coating medium.

17. A method of protecting a bolted construction joint fixing as claimed in claim 16, in which the cover is pushed onto a bolt head or onto a nut forming a fixing of the bolted construction joint.

18. A method of protecting a bolted construction joint fixing as claimed in claim 16, in which the cover is screwed onto the bolted construction joint.

19. A method of manufacturing a bolted construction joint fixing comprises stamping a piece of metal into a shape having a hexagonal opening and forming attachment sections in side walls of the hexagonal opening.

20. The method as claimed in claim 19, in which the attachment sections are projections into the hexagonal opening.

21. The method as claimed in claim 20, in which the projections are blisters in the surface of the side walls or slotted tabs in the side walls.
